(19) United States
(12) Patent Application Publication
(10) Pub. No.: US 2022/0173911 A1
(43) Pub. Date: Jun. 2, 2022

(54) METHOD AND NODES FOR HANDLING SYSTEM INFORMATION

(71) Applicant: Telefonaktiebolaget LM Ericsson (publ), Stockholm (SE)

(72) Inventors: Oscar Ohlsson, BROMMA (SE); Jens Bergqvist, LINKÖPING (SE); Prajwol Kumar Nakarmi, SOLLENTUNA (SE)

(21) Appl. No.: 17/437,645

(22) PCT Filed: Feb. 11, 2020
(86) PCT No.: PCT/SE2020/050134

§ 371 Date: Sep. 9, 2021

Related U.S. Application Data
(60) Provisional application No. 62/816,940, filed on Mar. 12, 2019.

(51) Int. Cl. H04L 9/32; H04L 9/40; H04W 48/08

(52) U.S. Cl. CPC H04L 9/3247; H04W 48/08; H04L 63/123; H04L 63/08

(57) ABSTRACT

The present disclosure relates to a method performed by a UE (103) for handling signing of system information (SI). The UE (103) obtains, from a network node (101), a first indication which indicates that a first network (100a) is adapted to sign the SI. The signed SI is signed by the first network (100a) using a signature.

### TECHNICAL FIELD

The present disclosure herein relate generally to a User Equipment (UE), a method performed by the UE, a network node and a method performed by the network node. More particularly it relates to handling System Information (SI) and signing of SI.

### BACKGROUND

SI is information that is repeatedly broadcast by the network, e.g. a network node comprised in the network, and which needs to be acquired by UE in order for it to be able to access and, in general, operate properly within the network and within a specific cell.

In New Radio (NR), SI is delivered using two different mechanisms relying on two different transport channels:
A limited amount of SI, corresponding to the so-called Master-Information Block (MIB), is transmitted using the Broadcast Channel (BCH).
The main part of the SI, corresponding to different so-called System Information Blocks (SIBs), is transmitted using the Downlink-Shared Channel (DL-SCH).

The first SIB, SIB1, comprises the SI that the UE needs to know before it can access the system or network. SIB1 is always periodically broadcast over the entire cell area. An important task of SIB1 is to provide the information which the UE needs in order to carry out initial random access. SIB1 also comprises scheduling information for the remaining SIBs. MIB and SIB1 together forms what is known as the Minimum SI.

The remaining SIBs, not comprising SIB1, is known as the Other SI and comprises the SI that a UE does not need to know before accessing the system or network. These SIBs can also be periodically broadcast similar to SIB1. Alternatively, these SIBs can be transmitted on demand, that is, only transmitted when explicitly requested by the UE. This implies that the network can avoid periodic broadcast of these SIBs in cells where no UE is currently camping, thereby allowing for enhanced network energy performance. Currently the following SIBs are defined:
SIB2 comprises cell re-selection information, mainly related to the serving cell;
SIB3 comprises information about the serving frequency and intra-frequency neighbouring cells relevant for cell re-selection, comprising cell re-selection parameters common for a frequency as well as cell specific re-selection parameters;
SIB4 comprises information about other NR frequencies and inter-frequency neighbouring cells relevant for cell re-selection, comprising cell re-selection parameters common for a frequency as well as cell specific re-selection parameters;
SIB5 comprises information about Evolved-Universal Terrestrial Radio Access (E-UTRA) frequencies and E-UTRA neighbouring cells relevant for cell re-selection, e.g. comprising cell re-selection parameters common for a frequency as well as cell specific re-selection parameters;
SIB6 comprises an Earthquake & Tsunami Warning System (ETWS) primary notification;
SIB7 comprises an ETWS secondary notification;
SIB8 comprises a Commercial Mobile Alert System (CMAS) warning notification;
SIB9 comprises information related to Global Positioning System (GPS) time and Coordinated Universal Time (UTC).

Three types of Radio Resource Control (RRC) message are used to transfer SI: the MIB message, the SIB1 message and the SI messages. An SI message, of which there may be several, comprises one or more SIBs which have the same scheduling requirements, i.e. the same transmission periodicity. The mapping of SIBs into SI messages as well as the scheduling information for those SI messages are defined in SIB1.

Today, SI is transmitted without integrity protection which means that an attacker can manipulate the SI without the UE to being able to detect it. As a result, UE may use that manipulated system information and be tricked to camp on a rogue cell leading to denial of service. The UE may also end up reporting false/incorrect information about neighbour cells to the genuine network which in turn could impact various Self-Organizing Network (SON) functions.

To mitigate this type of attacks one solution is to digitally sign the SI. Such solutions generally require the existence of Public Key Infrastructure (PKI) to generate, sign, and distribute certificates. Since not all operators might be willing invest in a PKI, signed SI may only be available in few networks initially. An operator might also choose to deploy the signature solution in gradual way, starting in a limited area and then expanding to the rest of the network. In addition, it is possible to only sign parts of the SI. For example, to avoid having to re-generate the signature all the time, SIBs that are updated often, e.g. SIB9 which comprises time information, can be excluded from the signature generation. Operators could also avoid PKI by having a secure way of provisioning necessary certificates and necessary public keys on the UE, e.g. Mobile Equipment (ME) or Universal Subscriber Identity Module (USIM).

The fact that SI is not signed everywhere causes a problem when the UE decides whether to reject or accept a cell. If the UE rejects all cells where the signature is missing, the UE may end up rejecting a cell which is authentic. On the other hand, if the UE accepts cells even if the signature is missing, then it may end up accepting a cell which is fake.

Similarly, the UE may also end up rejecting an authentic cell if the UE and network has different understanding of which parts of the SI that are covered by the signature. However, in this case the UE will not accept a fake cell because the attacker would not be able to generate any valid signature.

A naïve solution to the above problem would be to never reject a cell and instead display a warning to the user when the SI is not signed. Not only would such solution have limited effect—users tend to ignore warnings—it also assumes that a human interface is available which is not always the case.

Therefore, there is a need to at least mitigate or solve this issue.

### SUMMARY

An objective is therefore to obviate at least one of the above disadvantages and to improve handling of SI and handling of signed SI.

The object is achieved by the accompanying claims.

According to a first aspect, the object is achieved by a method performed by a UE for handling signing of SI. The UE obtains, from a network node, a first indication which indicates that a first network is adapted to sign the SI. The signed SI is signed by the first network using a signature.

According to a second aspect, the object is achieved by a method performed by a network node for handling signing of SI. The network node provides, to the UE, a first indication which indicates that a first network is adapted to sign the SI. The signed SI is signed by the first network using a signature.

According to a third aspect, the object is achieved by a UE for handling signing of SI. The UE is adapted to obtain, from a network node, a first indication which indicates that a first network is adapted to sign the SI. The signed SI is signed by the first network using a signature.

According to a fourth aspect, the object is achieved by a network node for handling signing of SI. The network node is adapted to provide, to the UE, a first indication which indicates that a first network is adapted to sign the SI. The signed SI is signed by the first network using a signature.

The present disclosure affords many advantages, of which a non-exhaustive list of examples follows:

The UE is informed about which networks, and potentially which areas or parts of a network, that uses signed SI as well as which parts of the SI that is covered by the signature. This in turn has a number of advantages:

One advantage is that signed SI does not need to be deployed by all networks and in all areas or parts of a network at once. Operators that are interested in signed SI and that are willing to do the required investment in a PKI, or investment in secure provisioning can deploy the feature in their network, or parts of their network, without being dependent that other operators are also deploying the feature.

Another advantage is that the network administrator may choose to only sign parts of the SI. SI that is not considered critical or that is frequently updated can be excluded from the signature generation.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be further described in more detail by way of example only in the following detailed description by reference to the appended drawings in which:

FIG. 1 is a schematic block diagram illustrating a communications system.

FIG. 2 is a signaling diagram illustrating a method.

FIG. 3 is a flow chart illustrating a method performed by the UE.

FIG. 4 is a flow chart illustrating a method performed by the network node.

FIG. 5a-5b are schematic drawings illustrating a UE.

FIG. 6a-6b are schematic drawings illustrating a network node.

FIG. 32 is a schematic block diagram illustrating a telecommunication network connected via an intermediate network to a host computer.

FIG. 33 is a schematic block diagram of a host computer communicating via a base station with a UE over a partially wireless connection.

FIG. 34 is a flowchart depicting a method in a communications system comprising a host computer, a base station and a UE.

FIG. 35 is a flowchart a method in a communications system comprising a host computer, a base station and a UE.

FIG. 36 is a flowchart depicting a method in a communications system comprising a host computer, a base station and a UE.

FIG. 37 is a flowchart depicting a method in a communications system comprising a host computer, a base station and a UE.

The drawings are not necessarily to scale and the dimensions of certain features may have been exaggerated for the sake of clarity. Emphasis is instead placed upon illustrating the principle.

### DETAILED DESCRIPTION

To ensure that the UE does not reject authentic cells due to missing signature, the UE is informed about which networks, and potentially which areas or parts of the network, that uses signed SI. For networks that uses signed SI, the UE is also informed about which parts of the SI that is covered by the signature.

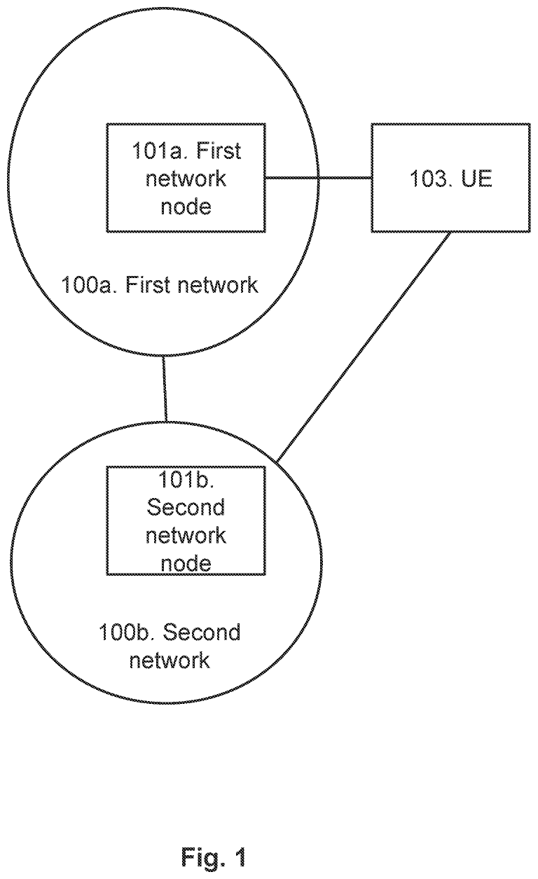

FIG. 1 depicts a communications system, which may be a wireless communications system, sometimes also referred to as a wireless communications network, cellular radio system, or cellular network. The communications system may be a Fifth Generation (5G) system, 5G network, NR-U or Next Gen system or network. The communications system 100 may alternatively be a younger system than a 5G system. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G/NR and LTE may be used in this disclosure to exemplify, this should not be seen as limiting to only the aforementioned systems.

FIG. 1 shows a first network 100a comprising a first network node 101a. FIG. 1 shows a second network 100b comprising a second network node 101b. FIG. 1 also shows a UE 103.

The first network 100a and/or the second network 100b comprises one or a plurality of network nodes, whereof the first network node 101a and the second network node 101b are depicted in FIG. 1. Any of the first network node 101a and the second network node 101b may be a radio network node, such as a radio base station, or any other network node with similar features capable of serving a user equipment, such as a wireless device or a machine type communication device, in the communications system 100. The first network node 101a may be an eNB and the second network node 101b may be a gNB. The first network node 101a may be a first eNB, and the second network node 101b may be a second eNB. The first network node 101a may be a first gNB, and the second network node 101b may be a second gNB. The first network node 101a may be a MeNB and the second network node 101b may be a gNB. Any of the first network node 101a and the second network node 101b may be co-localized, or be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The first network 100a and the second network 100b cover a geographical area which may be divided into cell areas, wherein each cell area may be served by a network node, although, one network node may serve one or several cells. Note that any n number of cells may be comprised in the first network 100a and the second network 100b, where n is any positive integer. A cell is a geographical area where radio coverage is provided by the network node at a network node site. Each cell is identified by an identity within the local network node area, which is broadcast in the cell. In FIG. 1, first network node 101a serves the first cell, and the second network node 101b serves the second cell. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 1 for the sake of simplicity. Any of the first network node 101a and the second network node 101b may be a distributed node, such as a virtual node in the cloud, and it may perform its functions entirely on the cloud, or partially, in collaboration with another network node. The first cell may be referred to as a source cell, whereas the second cell may be referred to as a target cell.

One or a plurality of UEs 103 is located in the communication system of FIG. 1. Only one UE 103 is exemplified in FIG. 1 for the sake of simplicity. A UE 103 may also be referred to simply as a device. The UE 103, e.g. a LTE UE or a 5G/NR UE, may be a wireless communication device which may also be known as e.g. a wireless device, a mobile terminal, wireless terminal and/or mobile station, a mobile telephone, cellular telephone, or laptop with wireless capability, just to mention some further examples. The UE 103 may be a device by which a subscriber may access services offered by an operator's network and services outside operator's network to which the operator's radio access network and core network provide access, e.g. access to the Internet. The UE 103 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, Internet of Things (IOT) device, terminal device, communication device or any type of consumer electronic, for instance but not limited to television, radio, lighting arrangements, tablet computer, laptop or Personal Computer (PC). The UE 103 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system.

The UE 103 is enabled to communicate wirelessly within the communications system. The communication may be performed e.g. between two devices, between a devices and a regular telephone, between the UE 103 and a network node 101, between network nodes 101, and/or between the UE 103 and a server via the radio access network and possibly one or more core networks and possibly the internet.

The first network node 101a may be configured to communicate in the first network 100a with the UE 103 over a first communication link, e.g., a radio link. The second network node 101b may be configured to communicate in the second network 100b with the UE 103 over a second communication link, e.g., a radio link. The first network node 101a may be configured to communicate with the second network node 101b over a third communication link, e.g., a radio link or a wired link, although communication over more links may be possible.

It should be noted that the communication links in the communications network may be of any suitable kind comprising either a wired or wireless link. The link may use any suitable protocol depending on type and level of layer, e.g. as indicated by the Open Systems Interconnection (OSI) model.

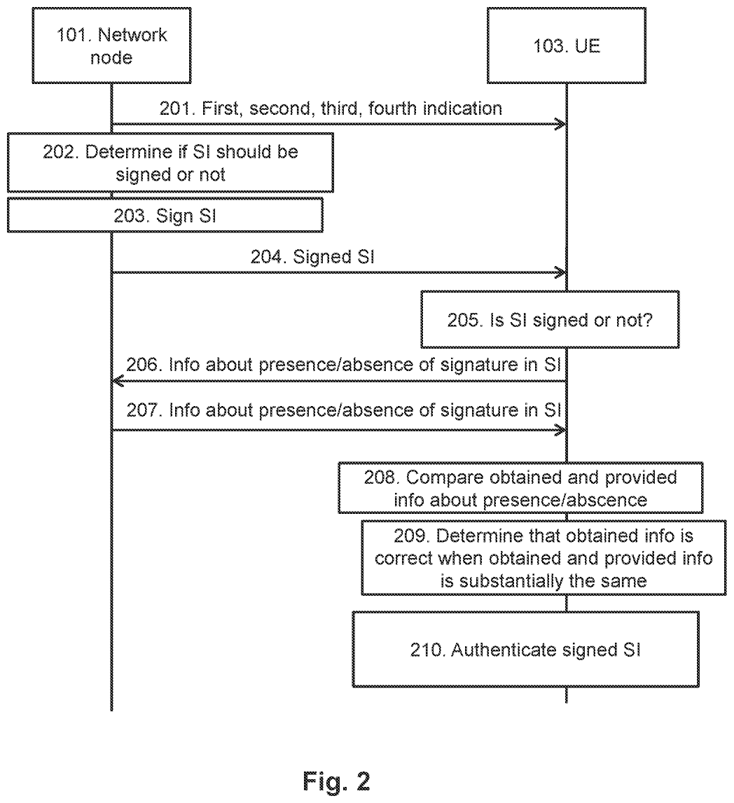

FIG. 2 is a signaling diagram illustrating a method. The network node 101 may be any of the first network node 101a and the second network node 101b. The method comprises at least one of the following steps, which steps may be performed in any suitable order than described below:

Step 201

The network node 101 provides at least one of a first indication, second indication, third indication and fourth indication to the UE 103. The UE 103 obtains at least one of the first indication, second indication, third indication and fourth indication from the network node 101. At least one of the first indication, second indication, third indication and fourth indication may be determined by the network node 101 or received from a CN node, e.g. an AMF.

Step 202

The network node 101 may determine if SI should be signed or not. The decision may be taken based on preconfigured information, based on information obtained from another network node, based on information from the UE 103 or based on other suitable information.

Step 203

If the decision in step 202 was to sign the SI, then the network node 101 may sign the SI in this step 203. The network node 101 may sign the SI using a signature. The signature may be also referred to as a key, an encryption key, a security key, identification key, an authentication key etc. The purpose of the signing the SI using the signature may be described as for verifying the authenticity of the SI. When the SI is verified by the UE 103 as being authentic, then the UE 103 knows that the SI was provided and created by the known network node 101. The network node 101 may use any suitable signing algorithm for signing the SI with the signature.

The signature may be created using any suitable algorithm for signature creation, e.g. a signature generation algorithm.

Step 204

The network node 101 provides the signed SI to the UE 103. The UE 103 obtains the signed SI from the network node 101.

Step 205

The UE 103 may determine if the SI from step 204 is signed or not.

Step 206

The UE 103 may provide information about the presence or absence of the signature in the SI to the network node 101, i.e. it provides information about the decision in step 205.

Step 207

The network node 101 may also provide information about the presence or absence of the signature in the SI to the UE 103.

Step 208

The UE 103 may compare the obtained and provided information about presence and absence of signature in the SI, i.e. it compares the information from steps 206 and 207.

Step 209

The UE 103 may determine that the obtained information is correct when the obtained and provided information is substantially the same, i.e. when the result of the comparison in step 208 indicates that the information is substantially the same.

Step 210

The UE 103 may authenticate the signed SI which it obtained in step 204. This step may also be described as or comprise interpreting, decrypting or verifying the signed SI. This step may be performed after step 204 or after any of steps 205-209.

The UE 103 may use any suitable signature authentication algorithm in order to authenticate the signed SI. The algorithm may also be referred to as a signature verifying algorithm which verifies the signed SI.

The UE 103 is informed about which networks, or areas or parts of a network, that use signed SI and what parts of the SI that is covered by the signature. How the signature is generated, e.g. which algorithm and key to use, and in what message or field the signature is conveyed to the UE may be done in any suitable order.

When the text herein describes the network node 101 performs an action or method step, this may also be described as the network performs a certain action or method steps. In other words, the network may be represented by a network node 101 performing the action or method step described herein.

To inform the UE 103 about which networks that uses signed SI the following options may be considered:
Provisioning method—The network node 101, e.g. comprised in a Home Public Land Mobile Network (HPLMN)—home operator's network—may provision the UE 103, e.g. the ME or the USIM, with an indication whether the SI is signed in the network, HPLMN or Visited Public Land Mobile Network (VPLMN)—visited operator's network. The network node 101, comprised in e.g. the HPLMN or the VPLMN may also provision such information for other VPLMNs that have roaming agreements with the network, e.g. HPLMN or VPLMN. The network node 101, comprised in e.g. the HPLMN or the VPLMN, may also provision such information for other VPLMNs that do not have roaming agreements with the HPLMN network, for example using some source of information like crowd sourced database, or results from field tests.
Dynamic method—The UEs 103 trying to attach to the network for the first time may not know anything and may ignore signatures. But once in connected mode, network node 101 may tell UE 103 that it uses signed SI. From that point onwards, the UE 103 may make sure that the SI must have a valid digital signature in that network. The indication that the network in which the network node 101 is located is using signed SI may for example be provided over Non-Access Stratum (NAS) as part of the initial registration procedure and may be protected using NAS level security. Another option may be to provide the indication over an Application Server (AS) using an RRC message protected using AS level security.
Another Dynamic method—the same as the above dynamic method, but the UE 103 may fetch information whether, and then potentially also how, the network uses the signed SI via Internet or another UE or any non-Third Generation Partnership Project (non-3GPP) protocol or network function, e.g., from secure web server using Hypertext Transfer Protocol Secure (HTTPS).

The indication of where the SI is signed may be provided on a network level, e.g. a PLMN level. If finer granularity is needed, the areas or parts of the network where the SI is signed may be indicated. This may be done by e.g. providing a list of tracking areas, Radio Access Network (RAN) areas, Access Network (AN) areas or cell identifiers. As an alternative, the indication may be given as explicit areas where the SI is not signed, e.g. providing a list of tracking areas, RAN areas or cell identifiers where the SI is not signed. In such areas, the UE 103 should then not expect signed SI, whereas in other areas the UE 103 should expect signed SI.

The parts of the SI that is covered by the signature may either be fixed in the standard, e.g. only SIB1 or only MIB and SIB1, or it may be indicated to the UE 103 using either of the solutions above. In the latter case, the indication may be seen as a generalization of the indication described above, i.e. a signature is present if and only if at least some part of the SI is covered by the signature. It is also possible to indicate the parts of the SI that is covered by the signature as part of the SI itself. For example, assuming that SIB1 is always covered by the signature, SIB1 may comprise a list of the other SIBs, i.e. SIBx, x>1, that are also covered by the signature. MIB may also comprise a field saying that this network has signatures for SIs. It may also be that SI messages that come later actually comprise information about at least one of presence or absence of signature for itself and previous SI messages. For example, SIB3 may comprise information that certain MIB and certain SIB1 are integrity protected and the signature is a certain value.

Doing so will help UEs 103 to determine the authenticity of previously used SI messages at a later time. Such late detection may be beneficial and may be considered as opportunistic use, i.e. use first and react later if the signature fails or is invalid. Previous MIB and SI messages may be determined by the frame number or the time slot, or at least one of relative clock time and absolute clock time, or a relative frame number, etc.

The network node 101 may also indicate or tell the UE 103 which parts of a particular SI are covered by signing, e.g. all the fields of SIB1, or only some particular fields of SIB1, all fields of MIB, or only some particular fields of MIB, etc.

The above indications may also be standardized, in coarse or granular level, e.g. in one of the 3GPP technical specifications. E.g., for certain network, areas or parts of the network, like the network code=some value, cell identifier=some value, or offering public safety services, certain SIBs must have signatures, and how the UE 103 should handle presence or absence of those signatures.

The handling of above indications may also be agreed between the UE vendors or smart card vendors and network operators, e.g., which SIBs contain signature and how to handle absence of them in a private network like a factory.

The above indications may also have other parameters in addition to or instead of presence or absence of signatures. One example is timing or validity period. Such timing may be useful for temporarily turning on and off the signatures, like turning off signatures during a rainy day or during natural disaster time. Another example is an action to take. Such action to take may be useful to let the UEs 103 know how to behave, like whether to ignore invalid signatures, or whether to transition to connected mode in case of invalid signatures, or log or report or send message to some other entities like the network or an internet server.

The UE 103 may inform the network, e.g. using a RRC message or a NAS message or some internet protocols like Internet Protocol (IP), Hypertext Transfer Protocol (HTTP), etc., the presence or absence of signatures in the SI that the UE 103 has received. Doing this may be helpful for dynamic methods mentioned above. E.g. when the UE 103 ignores or does not look for signatures during the first time, the UE 103 may still send the information to the network, e.g., as a part of the registration procedure or during the NAS security mode command procedure or the AS security mode command procedure. The information may be for example one or more of:
SIB1, signed=true,
MIB, signed=true,
SIB1, field_1_signed=true, field_2_signed=false,
SIB1, signature=0xFFFFAAAAAA, where 0xFFFFAAAAAA is a signature value,
SIB6, signed=false, etc.

The network node 101 and the UE 103 may make sure that this information is not tampered by an attacker by sending this information in security protected, integrity protected and optionally ciphered, messages. Another option is that network node 101 may resend the information sent by UE 103 to the UE 103 again in security protected message, so that the UE 103 may check if the resent information is correct. Another option may be that the network node 101 and the UE 103 may validate that a HASH of the information is correct. For these purposes, NAS or RRC procedures may be used, e.g., the registration procedure or during the NAS security mode command procedure or the AS security mode command procedure.

Note that although the methods above are described in the context of NR, the same methods may be applied to any access technologies that make use of SI like LTE or Narrowband-Internet of Things (NB-IoT).

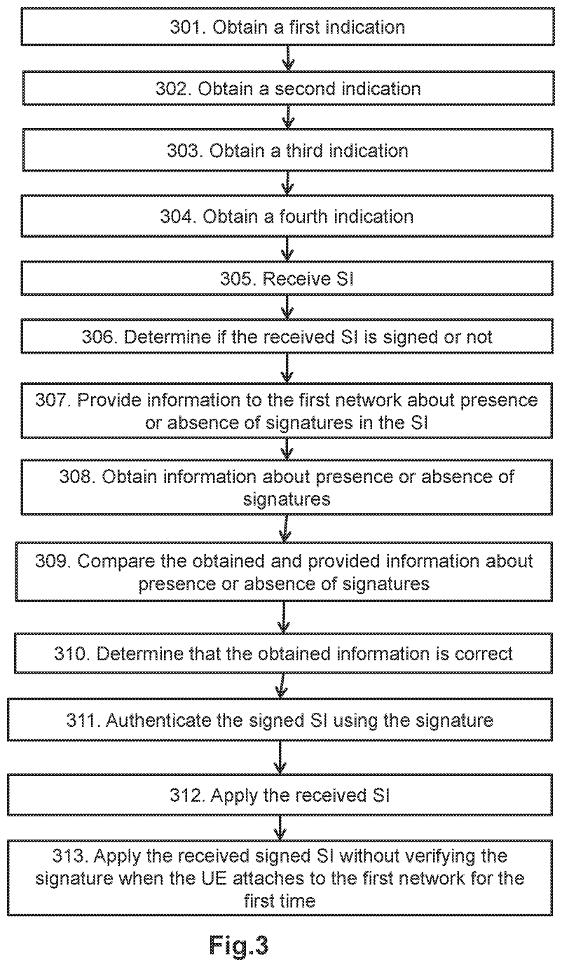

The method described above will now be described seen from the perspective of the UE 103. FIG. 3 is a flowchart describing the present method performed by the the UE 103 for handling signing of SI.

The at least one second network 100b may have a roaming agreement with the first network 100a or may not have any roaming agreement with the first network 100a. The first network 100a may be a HPLMN or a VPLMN of the UE 101. The second network 100b may be a HPLMN or a VPLMN of the UE 101.

At least one of the first network 100a and the second network 100b may be a 2G network, a 3G network, a 4G network, a 5G network, a 6G network or any other legacy, current or future network.

The method illustrated in FIG. 3 comprises at least one of the following steps to be performed by the UE 103, which steps may be performed in any suitable order than described below:

Step 301

This step corresponds to step 201 in FIG. 2. The UE 103 obtains a first indication from the network node 101. The first indication may indicate that a first network 100a is adapted to sign the SI. The signed SI is signed by the first network 100a using the signature. The network node 101 may be the first network node 101a or the second network node 101b. The first indication may be associated with a timer. The first network 100a may be adapted to sign the SI when the timer is running, i.e. when it has not expired.

Step 302

This step corresponds to step 201 in FIG. 2. The UE 103 may obtain a second indication from the network node 101. The second indication may indicate which parts of the SI that is covered by the signature. The SI may be previously obtained, currently obtained or obtained in the future.

Obtaining the second indication may comprise receiving the second indication from the network, directly or via some intermediate node, e.g. a memory unit, a cloud unit. The second indication may be obtained by being predefined by the standard, e.g. predefined in the UE 103.

Step 303

This step corresponds to step 201 in FIG. 2. The UE 103 may obtain a third indication from the network node 101. The third indication may indicate at least one second network 100b that is adapted to sign the SI.

Step 304

This step corresponds to step 201 in FIG. 2. The UE 103 may obtain a fourth indication from the network node 101. The fourth indication may indicate at least one of:
which parts of the first network 100a which is adapted to sign the SI, and
which parts of the first network 100a which is not adapted to sign the SI.

At least one of the first indication, the second indication, the third indication and the fourth indication may be obtained when the UE 103 is in connected mode.

At least one of the first indication, the second indication, the third indication and the fourth may be is obtained by being provisioned to the UE 103 by a first network node 101a comprised in the first network 100a.

At least one of the first indication, the second indication, the third indication and the fourth indication may be obtained over NAS in an initial registration procedure.

At least one of the first indication, the second indication, the third indication and the fourth indication may be obtained over AS in an RRC message.

The obtained at least one of the first indication, the second indication, the third indication and the fourth indication may be security protected.

At least one of the first indication, the second indication, the third indication and the fourth indication may be obtained from the network node 101. The network node 101 may be at least one of: a first network node 101a, a second network node 101b, a data network, another UE, a network function and a non-3GPP protocol.

Step 305

This step corresponds to step 204 in FIG. 2. The UE 103 may receive the SI from the network node 101. The SI may be signed or unsigned.

A first part of the received signed SI may always be covered by the signature. The first part may indicate at least one second part of the received signed SI that is also covered by the signature.

Step 306

This step corresponds to step 205 in FIG. 2. The UE 103 may determine if the received SI is signed or not.

Step 307

This step corresponds to step 206 in FIG. 2. The UE 103 may provide information to the first network 100a about presence or absence of signatures in the SI that the UE 103 has received.

The information about presence or absence of signatures in system information provided to the first network 100a may be security protected, e.g. integrity protected and/or ciphered.

Step 308

This step corresponds to step 207 in FIG. 2. The UE 103 may obtain, from the network node 101, information about presence or absence of signatures in the SI that the UE 103 has received from the first network 100a. The information may be obtained after the UE 103 has provided the same information to the first network 100a (step 307). The information may be security protected.

Step 309

The UE 103 may compare the obtained and provided information about presence or absence of signatures in the SI.

Step 310

The UE 103 may determine that the obtained information is correct when the comparison indicates that the obtained and provided information are at least substantially the same, i.e. that they match. When they are at least substantially the same, they may be exactly the same or there may be some acceptable tolerance level when comparing.

When the comparison indicates that the obtained and provided information are different, i.e. that they do not match, then the UE 103 may determine that the obtained information is not correct.

Step 311

This step corresponds to step 210 in FIG. 2. The UE 103 may authenticate the received SI using the signature if it is signed. The signature is used to verify the integrity and to authenticate the origin of the SI.

Step 312

The UE 103 may apply the received SI if is not signed, or if the authentication in step 304 is successful.

Step 313

The UE 103 may apply the received signed SI without verifying the signature when the UE 103 attaches to the first network 100a for the first time. The SI may comprise parameters which are necessary to establish the radio connection between the UE 103 and network and hence it may not be able to perform the initial attach if the SI is ignored.

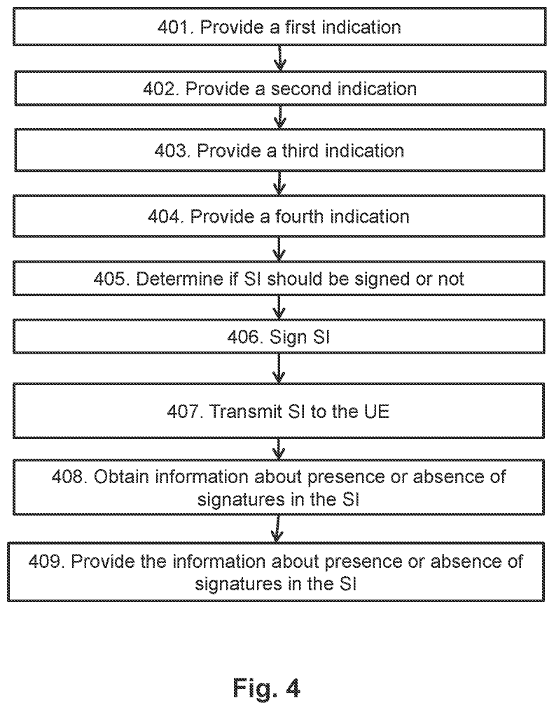

The method described above will now be described seen from the perspective of the network node 101. FIG. 4 is a flowchart describing the present method performed by the network node 101 for handling signing of SI.

The network node 101 may be a first network node 101a comprised in the first network 100a, a second network node 101b comprised in the second network 100b or in any other network node.

The method comprises at least one of the following steps to be performed by the network node 101, which steps may be performed in any suitable order than described below:

Step 401

This step corresponds to step 201 in FIG. 2. The network node 101 provides a first indication to the UE 103. The first indication indicates that a first network 100a is adapted to sign the SI. The signed SI is signed by the first network 100a using a signature.

The first indication may be associated with a timer. The first network 100a may be adapted to sign the SI when the timer is running, i.e. when it has not expired.

The first indication may be determined by the network node 101 or it may be received from a CN node. e.g. an AMF node.

Step 402

This step corresponds to step 201 in FIG. 2. The network node 101 may provide a second indication to the UE 103. The second indication may indicate which parts of the SI that is covered by the signature. The SI may be previously provided, currently provided or provided in the future.

Step 403

This step corresponds to step 201 in FIG. 2. The network node 101 may provide a third indication to the UE 103. The third indication may indicate at least one second network 100b that is adapted to sign the SI.

Step 404

This step corresponds to step 201 in FIG. 2. The network node 101 may provide a fourth indication to the UE 103. The fourth indication may indicate at least one of:
which parts of the first network 100a which is adapted to sign the SI, and
which parts of the first network 100a which is not adapted to sign the SI.

At least one of the first indication, the second indication, the third indication and the fourth indication may be provided when the UE 103 is in connected mode.

At least one of the first indication, the second indication, the third indication and the fourth indication may be provided by being provisioned by the network node 101 being a first network node 101a comprised in the first network 100a.

At least one of the first indication, the second indication, the third indication and the fourth indication may be provided to the UE 103 over NAS in an initial registration procedure.

At least one of the first indication, the second indication, the third indication and the fourth indication may be provided to the UE 103 over AS in an RRC message.

At least one of the first indication, the second indication, the third indication and the fourth indication may be security protected.

At least one of the first indication, the second indication, the third indication and the fourth indication may be provided from the network node 101 being a first network node 101a, a data network, another UE, a network function or a non-3GPP protocol.

At least one of the first indication, the second indication, the third indication and the fourth indication may be provided by transmitting it to the UE 103, directly or via some intermediate node, e.g. a memory unit, a cloud unit etc.

Step 405

The network node 101 may determine if SI should be signed or not.

Step 406

The network node 101 may sign the SI if it has been determined to do so.

Step 407

The network node 101 may transmit the signed or unsigned SI to the UE 103.

A first part of the transmitted signed SI may always be covered by the signature. The first part may indicate at least one second part of the transmitted signed SI that is also covered by the signature.

Step 408

The network node 101 may obtain information from the UE 103 about presence or absence of signatures in the SI that the UE 103 has received from the network node 101.

The information about presence or absence of signatures in system information obtained from the UE 103 may be security protected, e.g. integrity protected and/or ciphered.

Step 409

The network node 101 may provide the information about presence or absence of signatures in the SI that the UE 103 has received from the first network 100a. The information may be provided after the network node 101 has obtained the same information from the UE 103. The information may be security protected.

The at least one second network 100b may have a roaming agreement with the first network 100a or may not have any roaming agreement with the first network 100a.

The first network 100a may be a HPLMN or a VPLMN of the UE 101, and the second network 100b may be a HPLMN or a VPLMN of the UE 101.

At least one of the first network 100a and the second network 100b may be a 2G network, a 3G network, a 4G network, a 5G network, a 6G network or any other legacy, current of future network.

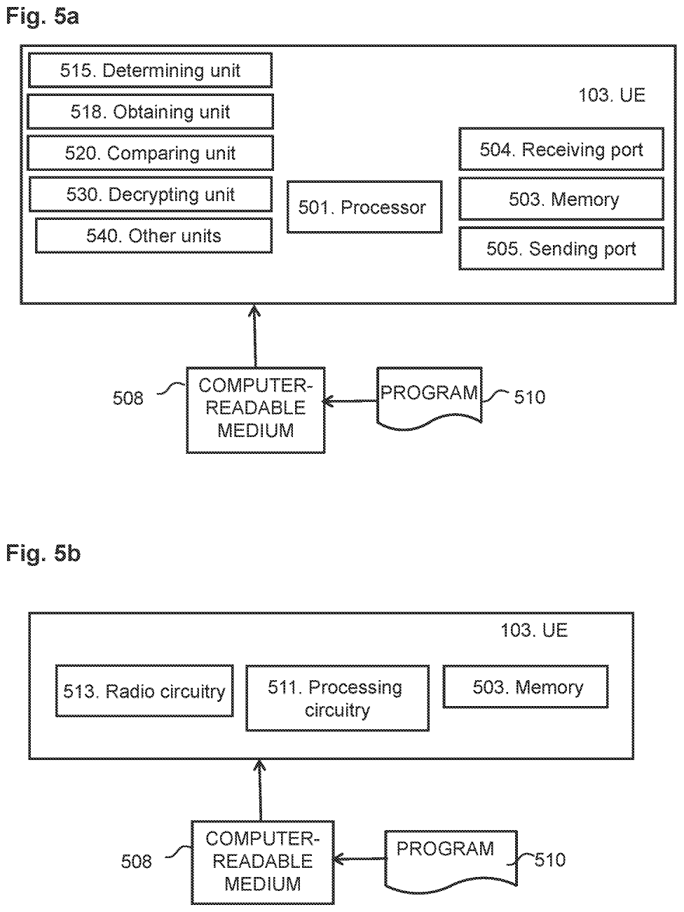

FIG. 5a and FIG. 5b depict two different examples in panels a) and b), respectively, of the arrangement that the UE 103 may comprise. The UE 103 may comprise the following arrangement depicted in FIG. 5a.

The present disclosure in the UE 103 may be implemented through one or more processors, such as a processor 501 in the UE 103 depicted in FIG. 5a, together with computer program code for performing the functions and actions described herein. A processor, as used herein, may be understood to be a hardware component. The program code mentioned above may also be provided as a computer program product, for instance in the form of a data carrier carrying computer program code for performing the what is disclosed herein when being loaded into the UE 103. One such carrier may be in the form of a CD ROM disc. It is however feasible with other data carriers such as a memory stick. The computer program code may be provided as pure program code on a server and downloaded to the UE 103.

The UE 103 may comprise a memory 503 comprising one or more memory units. The memory 503 is arranged to be used to store obtained information, store data, configurations, schedulings, and applications etc. to perform the methods herein when being executed in the UE 103.

The UE 103 may receive information from, e.g. at least one of the first network node 101a and the second network node 101b, through a receiving port 504. The receiving port 504 may be connected to one or more antennas in UE 103. The UE 103 may receive information from another structure in the communications system through the receiving port 504. Since the receiving port 504 may be in communication with the processor 501, the receiving port 504 may then send the received information to the processor 501. The receiving port 504 may also be configured to receive other information.

The processor 501 in the UE 103 may be configured to transmit or send information to e.g. at least one of the first network node 101a and the second network node 101b, or another structure in the communications system, through a sending port 505, which may be in communication with the processor 501, and the memory 503.

The UE 103 may comprise a determining unit 515, an obtaining unit 518, a comparing unit 520, and decrypting unit 530 and other units 540.

The UE 103 is adapted to, e.g. by means of the obtaining unit 518, obtain the first indication from the network node 101. The first indication which indicates that a first network 100a is adapted to sign the SI, wherein signed SI is signed by the first network 100a using a signature. A first part of the received signed SI may always be covered by the signature. The first part may indicate at least one second part of the received signed SI that is also covered by the signature. The first indication may be associated with a timer, and the first network 100a may be adapted to sign the SI when the timer is running.

The obtaining unit 518 may also be referred to as an obtaining module, an obtaining means, an obtaining circuit, means for obtaining etc. The obtaining unit 518 may be the processor 501 of the UE 103 or comprised in the processor 501 of the UE 103.

The UE 103 may be adapted to, e.g. by means of the obtaining unit 518, receive the SI from the first network 100a.

The UE 103 may be adapted to, e.g. by means of the determining unit 515, determine if the received SI is signed or not. The determining unit 515 may also be referred to as a determining module, a determining means, a determining circuit, means for determining etc. The determining unit 515 may be the processor 501 of the UE 103 or comprised in the processor 501 of the UE 103.

The UE 103 may be adapted to, e.g. by means of the other units 540 such as an authentication unit, authenticate the received SI using the signature if it is signed. The other unit 540 may also be referred to as other module, other means, other circuit, means for performing other functions etc. The other unit 540 may be the processor 501 of the UE 103 or comprised in the processor 501 of the UE 103.

The UE 103 may be adapted to, e.g. by means of the other units 540 such as an applying unit, apply the received SI if it is not signed or if the authentication is successful.

The UE 103 may be adapted to, e.g. by means of the obtaining unit 518, obtain the second indication from the network node 101. The second indication may indicate which parts of the system information that is covered by the signature. The system information may be previously received, currently received or received in the future.

The UE 103 may be adapted to, e.g. by means of the obtaining unit 518, obtain the third indication from the network node 101. The third indication may indicate at least one second network 100b that is adapted to sign the SI.

The UE 103 may be adapted to, e.g. by means of the obtaining unit 518, obtain the fourth indication from the network node 101. The fourth indication may indicate at least one of:
which parts of the first network 100a which is adapted to sign the SI, and
which parts of the first network 100a which is not adapted to sign the SI.

The at least one second network 100b may have a roaming agreement with the first network 100a or may not have any roaming agreement with the first network 100a.

The first network 100a may be a HPLMN or a VPLMN of the UE 101, and the second network 100b may be a HPLMN or a VPLMN of the UE 101.

At least one of the first indication, the second indication, the third indication and the fourth indication may be obtained when the UE 103 is in connected mode.

The UE 103 may be adapted to, e.g. by means of the other units 540 such as e.g. an applying unit, applying the received signed SI without verifying the signature when the UE 103 attaches to the first network 100a for the first time.

At least one of the first indication, the second indication, the third indication and the fourth indication may be obtained by being provisioned by a first network node 101a comprised in the first network 100a.

At least one of the first indication, the second indication, the third indication and the fourth indication may be obtained over NAS in an initial registration procedure, or at least one of the first indication, the second indication, the third indication and the fourth indication may be obtained over AS in an RRC message.

The obtained at least one of the first indication, the second indication, the third indication and the fourth indication may be security protected.

At least one of the first indication, the second indication, the third indication and the fourth indication may be obtained from a first network node 101a, a data network, another UE, a network function, a non-3GPP protocol.

The UE 103 may be adapted to, e.g. by means of the other units 540 such as a providing unit, provide information to the first network 100a about presence or absence of signatures in the SI that the UE 103 has received, e.g. to the first network node 101a comprised in the first network 100a. The information about presence or absence of signatures in system information provided to the first network 100a may be security protected, e.g. integrity protected and/or ciphered.

The UE 103 may be adapted to, e.g. by means of the obtaining unit 518, obtain, from the network node 101, the information about presence or absence of signatures in the SI that the UE 103 has received from the first network 100a. The information may be obtained after the UE 103 has provided the same information to the first network 100a. The information may be security protected.

The UE 103 may be adapted to, e.g. by means of the comparing unit 520, compare the obtained and provided information about presence or absence of signatures in the SI. The comparing unit 510 may also be referred to as comparing module, comparing means, comparing circuit, means for comparing etc. The comparing unit 540 may be the processor 501 of the UE 103 or comprised in the processor 501 of the UE 103.

The UE 103 may be adapted to, e.g. by means of the determining unit 515, determine that the obtained information is correct when the comparison indicates that the obtained and provided information are at least substantially the same.

At least one of the first network 100a and the second network 100b may be a 2G network, a 3G network, a 4G network, a 5G network, a 6G network or any other legacy, current of future network.

Those skilled in the art will also appreciate that the determining unit 515, the obtaining unit 518, the comparing unit 518, the decrypting unit 530 and other units 540 described above may refer to a combination of analog and digital circuits, and/or one or more processors configured with software and/or firmware, e.g., stored in memory, that, when executed by the one or more processors such as the processor 501, perform as described above. One or more of these processors, as well as the other digital hardware, may be comprised in a single Application-Specific Integrated Circuit (ASIC), or several processors and various digital hardware may be distributed among several separate components, whether individually packaged or assembled into a System-on-a-Chip (SoC).

The different units 515-540 described above may be implemented as one or more applications running on one or more processors such as the processor 501.

Thus, the methods described herein for the UE 103 may be respectively implemented by means of a computer program 510 product, comprising instructions, i.e., software code portions, which, when executed on at least one processor 501, cause the at least one processor 501 to carry out the actions described herein, as performed by the UE 103. The computer program 510 product may be stored on a computer-readable storage medium 508. The computer-readable storage medium 508, having stored thereon the computer program 510, may comprise instructions which, when executed on at least one processor 501, cause the at least one processor 501 to carry out the actions described herein, as performed by the UE 103. The computer-readable storage medium 508 may be a non-transitory computer-readable storage medium, such as a CD ROM disc, or a memory stick. The computer program 510 product may be stored on a carrier containing the computer program 510 just described, wherein the carrier is one of an electronic signal, optical signal, radio signal, or the computer-readable storage medium 508, as described above.

The UE 103 may comprise a communication interface configured to facilitate communications between the UE 103 and other nodes or devices, e.g. at least one of the first network node 101a, the second network node 101b, or another structure. The interface may, for example, comprise a transceiver configured to transmit and receive radio signals over an air interface in accordance with a suitable standard.

The UE 103 may comprise the following arrangement depicted in FIG. 5b. The UE 103 may comprise a processing circuitry 511, e.g., one or more processors such as the processor 501, in the UE 103 and the memory 503. The UE 103 may also comprise a radio circuitry 513, which may comprise e.g., the receiving port 504 and the sending port 505. The processing circuitry 511 may be configured to, or operable to, perform the method actions according to FIG. 2, in a similar manner as that described in relation to FIG. 5a. The radio circuitry 513 may be configured to set up and maintain at least a wireless connection with the UE 103. Circuitry may be understood herein as a hardware component.

The UE 103 may be operative to operate in the communications system. The UE 103 may comprise the processing circuitry 511 and the memory 503. The memory 503 comprises instructions executable by the processing circuitry 511. The UE 103 is operative to perform the actions described herein in relation to the UE 103, e.g. in FIG. 2.

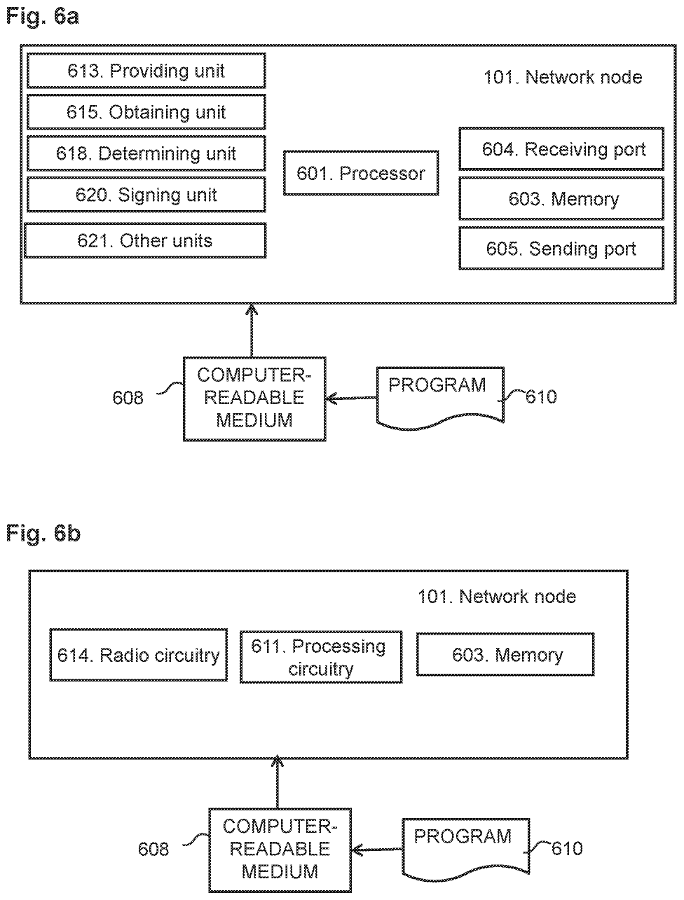

FIG. 6a and FIG. 6b depict two different examples in panels a) and b), respectively, of the arrangement that the network node 101 may comprise. The network node 101 may be at least one of the first network node 101a and the second network node 101b. The network node 101 may comprise the following arrangement depicted in FIG. 6a.

The present disclosure in the network node 101 may be implemented through one or more processors, such as a processor 601 in the network node 101 depicted in FIG. 6a, together with computer program code for performing the functions and actions described herein. A processor, as used herein, may be understood to be a hardware component. The program code mentioned above may also be provided as a computer program product, for instance in the form of a data carrier carrying computer program code for performing the methods described herein when being loaded into the network node 101. One such carrier may be in the form of a CD ROM disc. It is however feasible with other data carriers such as a memory stick. The computer program code may be provided as pure program code on a server and downloaded to the network node 101.

The network node 101 may comprise a memory 603 comprising one or more memory units. The memory 603 is arranged to be used to store obtained information, store data, configurations, schedulings, and applications etc. to perform the methods herein when being executed in the network node 101.

The network node 101 may receive information from, e.g. at least one of the UE 103 and another network node 101, through a receiving port 604. The receiving port 604 may be connected to one or more antennas in network node 101. The network node 101 may receive information from another structure in the communications system 100 via the receiving port 604. Since the receiving port 604 may be in communication with the processor 601, the receiving port 604 may then send the received information to the processor 601. The receiving port 604 may also be configured to receive other information.

The processor 601 in the network node 101 may be configured to transmit or send information to e.g. at least one of the UE 103, or another structure in the communications system, through a sending port 605, which may be in communication with the processor 601 and the memory 603.

The network node 101 may comprise a providing unit 613, an obtaining unit 615, a determining unit 618, a signing unit 620 and other units 621.

The network node 101 is adapted to, e.g. by means of the providing unit 613, provide the first indication to the UE 103. The first indication indicates that a first network 100a is adapted to sign the SI. The signed SI is signed by the first network 100a using a signature. The first part of the transmitted signed SI may always be covered by the signature. The first part may indicate at least one second part of the received signed SI that is also covered by the signature. The first indication may be associated with a timer. The first network 100a may be adapted to sign the SI when the timer is running. The first indication may be determined by the network node 101 or it may be received from the CN node. The CN node may be a Core Access and Mobility Management Function (AMF) or any other CN node adapted to determine the first indication and to send it to the network node 101.

The providing unit 613 may also be referred to as a providing module, a providing means, a providing circuit, means for providing etc. The providing unit 613 may be the processor 601 of the network node 101 or comprised in the processor 601 of the network node 101.

The network node 101 may be adapted to, e.g. by means of the determining unit 618, determine if the SI should be signed or not. The determining unit 618 may also be referred to as a determining module, a determining means, a determining circuit, means for determining etc. The determining unit 618 may be the processor 601 of the network node 101 or comprised in the processor 601 of the network node 101.

The network node 101 may be adapted to, e.g. by means of the signing unit 620, sign the SI if it has been determined to do so. The signing unit 628 may also be referred to as a signing module, a signing means, a signing circuit, means for signing etc. The signing unit 620 may be the processor 601 of the network node 101 or comprised in the processor 601 of the network node 101.

The network node 101 may be adapted to, e.g. by means of the other unit 621 such as a transmitting unit or the sending port 605, transmit signed or unsigned SI to the UE 103. The other unit 621 may also be referred to as other module, other means, other circuit, means for performing other features etc. The other unit 621 may be the processor 601 of the network node 101 or comprised in the processor 601 of the network node 101.

The network node 101 may be adapted to, e.g. by means of the providing unit 613, provide the second indication to the UE 103. The second indication may indicate which parts of the system information that is covered by the signature. The system information may be previously received, currently received or received in the future.

The network node 101 may be adapted to, e.g. by means of the providing unit 613, provide the third indication to the UE 103. The third indication may indicate at least one second network 100b that is adapted to sign the SI.

The network node 101 may be adapted to, e.g. by means of the providing unit 613, provide the fourth indication to the UE 103. The fourth indication may indicate at least one of:
which parts of the first network 100a which is adapted to sign the SI, and
which parts of the first network 100a which is not adapted to sign the SI.

The at least one second network 100b may have a roaming agreement with the first network 100a or may not have any roaming agreement with the first network 100a.

The first network 100a may be a HPLMN or a VPLMN of the UE 101, and the second network 100b may be a HPLMN or a VPLMN of the UE 101.

At least one of the first indication, the second indication, the third indication and the fourth indication may be provided when the UE 103 is in connected mode.

At least one of the first indication, the second indication, the third indication and the fourth indication may be provided by being provisioned by the network node 101 being a first network node 101a comprised in the first network 100a.

At least one of the first indication, the second indication, the third indication and the fourth indication may be provided to the UE 103 over NAS in an initial registration procedure, or at least one of the first indication, the second indication, the third indication and the fourth indication may be provided to the UE 103 over AS in an RRC message.

At least one of the first indication, the second indication, the third indication and the fourth indication may be security protected.

At least one of the first indication, the second indication, the third indication and the fourth indication may be provided from the network node 101 being a first network node 101a, a data network, another UE, a network function, a non-3GPP protocol.

The network node 101 may be adapted to, e.g. by means of the obtaining unit 615, obtain information from the UE 103 about presence or absence of signatures in the SI that the UE 103 has received form the network node 101. Information about presence or absence of signatures in SI obtained from the UE 103 may be security protected, e.g. integrity protected and/or ciphered.

The obtaining unit 615 may also be referred to as an obtaining module, an obtaining means, an obtaining circuit, means for obtaining etc. The obtaining unit 615 may be the processor 601 of the network node 101 or comprised in the processor 601 of the network node 101.

The network node 101 may be adapted to, e.g. by means of the providing unit 613, provide the information about presence or absence of signatures in the SI that the UE 103 has received from the first network 100a. The information may be provided after the network node 101 has obtained the same information from the UE 103. The information may be security protected.

At least one of the first network 100a and the second network 100b may be a 2G network, a 3G network, a 4G network, a 5G network, a 6G network or any other legacy, current of future network.

The network node 101 may be a first network node 101a comprised in the first network 100a, a second network node 101b comprised in the second network 100b or comprised in any other network node.

Those skilled in the art will also appreciate that the providing unit 613, the obtaining unit 615, the determining unit 618, the signing unit 620 and other units 621 described above may refer to a combination of analog and digital circuits, and/or one or more processors configured with software and/or firmware, e.g. stored in memory, that, when executed by the one or more processors such as the processor 601, perform as described above. One or more of these processors, as well as the other digital hardware, may be comprised in a single ASIC, or several processors and various digital hardware may be distributed among several separate components, whether individually packaged or assembled into a SoC.

The different units 613-621 described above may be implemented as one or more applications running on one or more processors such as the processor 601.

Thus, the methods described herein for the network node 101 may be respectively implemented by means of a computer program 610 product, comprising instructions, i.e., software code portions, which, when executed on at least one processor 601, cause the at least one processor 601 to carry out the methods described herein, as performed by the network node 101. The computer program 610 product may be stored on a computer-readable storage medium 608. The computer-readable storage medium 608, having stored thereon the computer program 610, may comprise instructions which, when executed on at least one processor 601, cause the at least one processor 601 to carry out the actions described herein, as performed by the network node 101. The computer-readable storage medium 610 may be a non-transitory computer-readable storage medium, such as a CD ROM disc, or a memory stick. The computer program 610 product may be stored on a carrier containing the computer program 610 just described. The carrier is one of an electronic signal, optical signal, radio signal, or the computer-readable storage medium 608, as described above.

The network node 101 may comprise a communication interface configured to facilitate communications between the network node 101 and other nodes or devices, e.g. at least one of the UE 103 and another structure. The interface may, for example, comprise a transceiver configured to transmit and receive radio signals over an air interface in accordance with a suitable standard.

The network node 101 may comprise the following arrangement depicted in FIG. 6b. The network node 101 may comprise a processing circuitry 611, e.g. one or more processors such as the processor 601, in the network node 101 and the memory 603. The network node 101 may also comprise a radio circuitry 614, which may comprise e.g. at least one of the receiving port 604 and the second sending port 605. The processing circuitry 611 may be configured to, or operable to, perform the method actions according to FIG. 2 in a similar manner as that described in relation to FIG. 6a. The radio circuitry 614 may be configured to set up and maintain at least a wireless connection with the network node 101. Circuitry may be understood herein as a hardware component.

The network node 101 operates in the communications system. The network node 101 may comprise the processing circuitry 611 and the memory 603. The memory 603 comprises instructions executable by said processing circuitry 611. The network node 101 is operative to perform the actions described herein in relation to the network node 101, e.g. FIG. 2.

### Further Extensions And Variations

A telecommunication network may be connected via an intermediate network to a host computer.

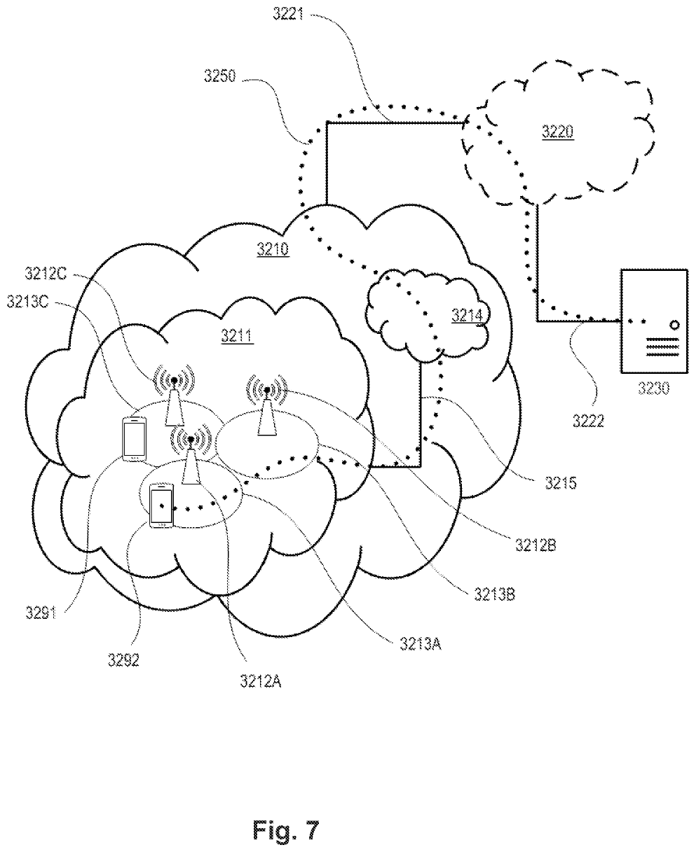

With reference to FIG. 32, a communication system comprises the telecommunication network 3210 such as the communications system 100, for example, a 3GPP-type cellular network, which comprises the access network 3211, such as a radio access network, and the core network 3214. The access network 3211 comprises a plurality of network nodes 101. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A plurality of user equipments, such as the UE 103 may be comprised in the communications system 100. In FIG. 32, a first UE 3291 located in coverage area 3213c is configured to wirelessly connect to, or be paged by, the corresponding base station 3212c. A second UE 3292 in the coverage area 3213a is wirelessly connectable to the corresponding base station 3212a. While a plurality of UEs 3291, 3292 are illustrated in FIG. 32, the present disclosure is equally applicable to a situation where a sole UE is in the coverage area or where a sole UE is connecting to the corresponding base station 3212. Any of the UEs 3291, 3292 may be considered examples of the UE 103.

The telecommunication network 3210 is itself connected to the host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. Connections 3221 and 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; intermediate network 3220, if any, may be a backbone network or the Internet; in particular, the intermediate network 3220 may comprise two or more sub-networks (not shown).

The communication system of FIG. 32 as a whole enables connectivity between the connected UEs 3291, 3292 and the host computer 3230. The connectivity may be described as an Over-The-Top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. The base station 3212 may not or need not be informed about the past routing of an incoming downlink communication with data originating from the host computer 3230 to be forwarded, e.g., handed over, to a connected UE 3291. Similarly, the base station 3212 need not be aware of the future routing of an outgoing uplink communication originating from the UE 3291 towards the host computer 3230.

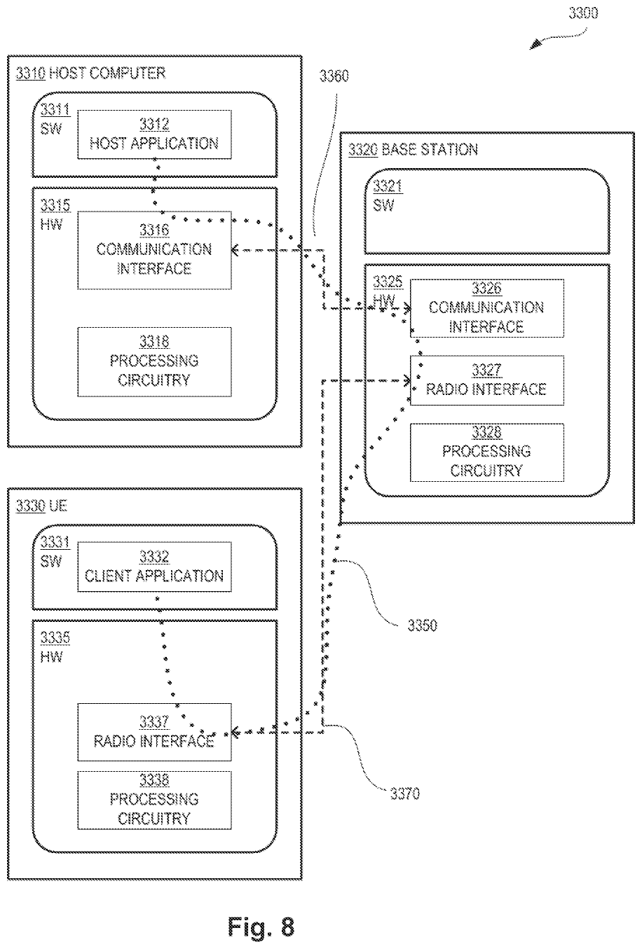

In relation to FIGS. 33-37 which are described next, it may be understood that the base station may be considered an example of the network node 101.

FIG. 33 illustrates a host computer communicating via a base station 101 with a UE 103 over a partially wireless connection.

The UE 103 and the network node 101, e.g., a base station and a host computer discussed in the preceding paragraphs will now be described with reference to FIG. 33. In the communication system 3330, such as the communications system 100, the host computer 3310 comprises the hardware 3315 comprising the communication interface 3316 configured to set up and maintain a wired or wireless connection with an interface of a different communication device of communication system 3300. The host computer 3310 comprises the processing circuitry 3318, which may have storage and/or processing capabilities. In particular, the processing circuitry 3318 may comprise one or more programmable processors, ASICs, FPGAs or combinations of these (not shown) adapted to execute instructions. The host computer 3310 comprises the software 3311, which is stored in or accessible by the host computer 3310 and executable by the processing circuitry 3318. The software 3311 comprises the host application 3312. The host application 3312 may be operable to provide a service to a remote user, such as the UE 3330 connecting via the OTT connection 3350 terminating at the UE 3330 and the host computer 3310. In providing the service to the remote user, the host application 3312 may provide user data which is transmitted using the OTT connection 3350.

The communication system 3300 comprises the network node 101 exemplified in FIG. 33 as a base station 3320 provided in a telecommunication system and comprising the hardware 3325 enabling it to communicate with the host computer 3310 and with the UE 3330. The hardware 3325 may comprise a communication interface 3326 for setting up and maintaining a wired or wireless connection with an interface of a different communication device of communication system 3300, as well as a radio interface 3327 for setting up and maintaining at least wireless connection 3370 with the UE 103, exemplified in FIG. 33 as a UE 3330 located in a coverage area (not shown in FIG. 33) served by the base station 3320. The communication interface 3326 may be configured to facilitate connection 3360 to the host computer 3310. The connection 3360 may be direct or it may pass through a core network (not shown in FIG. 33) of the telecommunication system and/or through one or more intermediate networks outside the telecommunication system. In the FIG. 33, the hardware 3325 of the base station 3320 comprises the processing circuitry 3328, which may comprise one or more programmable processors, ASICs, FPGSs or combinations of these (not shown) adapted to execute instructions. The base station 3320 comprises software 3321 stored internally or accessible via an external connection.

The communication system 3300 comprises the UE 3330 already referred to. It's hardware 3335 may comprise the radio interface 3337 configured to set up and maintain wireless connection 3370 with a base station serving a coverage area in which the UE 3330 is currently located. The hardware 3335 of the UE 3330 comprises the processing circuitry 3338, which may comprise one or more programmable processors, ASICs, FPGAs or combinations of these (not shown) adapted to execute instructions. The UE 3330 comprises the software 3331, which is stored in or accessible by the UE 3330 and executable by the processing circuitry 3338. The software 3331 comprises the client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, the base station 3320 and the UE 3330 illustrated in FIG. 33 may be similar or identical to the host computer 3230, one of the base stations 3212a, 3212b, 3212c and one of the UEs 3291, 3292 of FIG. 32, respectively. This is to say, the inner workings of these entities may be as shown in FIG. 33 and independently, the surrounding network topology may be that of FIG. 32.

In FIG. 33, the OTT connection 3350 has been drawn abstractly to illustrate the communication between the host computer 3310 and the UE 3330 via the base station 3320, without explicit reference to any intermediary devices and the precise routing of messages via these devices. The network infrastructure may determine the routing, which it may be configured to hide from the UE 3330 or from the service provider operating the host computer 3310, or both. While the OTT connection 3350 is active, the network infrastructure may take decisions by which it dynamically changes the routing, e.g., on the basis of load balancing consideration or reconfiguration of the network.

The wireless connection 3370 between the UE 3330 and the base station 3320 is in accordance with the present disclosure. They improve the performance of the OTT services provided to the UE 3330 using the OTT connection 3350, in which the wireless connection 3370 forms the last segment. The spectrum efficiency and latency may be improved, and thereby provide benefits such as reduced user waiting time, better responsiveness and extended battery lifetime.

A measurement procedure may be provided for the purpose of monitoring data rate, latency and other factors on which the present disclosure improve. There may be an optional network functionality for reconfiguring the OTT connection 3350 between the host computer 3310 and the UE 3330, in response to variations in the measurement results. The measurement procedure and/or the network functionality for reconfiguring the OTT connection 3350 may be implemented in the software 3311 and the hardware 3315 of the host computer 3310 or in the software 3331 and the hardware 3335 of the UE 3330, or both. Sensors (not shown) may be deployed in or in association with communication devices through which the OTT connection 3350 passes; the sensors may participate in the measurement procedure by supplying values of the monitored quantities exemplified above, or supplying values of other physical quantities from which the software 3311, 3331 may compute or estimate the monitored quantities. The reconfiguring of the OTT connection 3350 may comprise message format, retransmission settings, preferred routing etc. The reconfiguring need not affect the base station 3320, and it may be unknown or imperceptible to the base station 3320. Such procedures and functionalities may be known and practiced in the art. Measurements may involve proprietary UE signaling facilitating the host computer 3310's measurements of throughput, propagation times, latency and the like. The measurements may be implemented in that software 3311 and 3331 causes messages to be transmitted, in particular empty or ‘dummy’ messages, using the OTT connection 3350 while it monitors propagation times, errors etc.

FIG. 34 illustrates methods implemented in a communication system comprising a host computer, a base station and a UE. FIG. 34 is a flowchart illustrating a method implemented in a communication system. The communication system comprises a host computer, a base station and a UE which may be those described with reference to FIG. 32 and FIG. 33. For simplicity of the present disclosure, only drawing references to FIG. 34 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated. In step 3440 (which may also be optional), the UE executes a client application associated with the host application executed by the host computer.

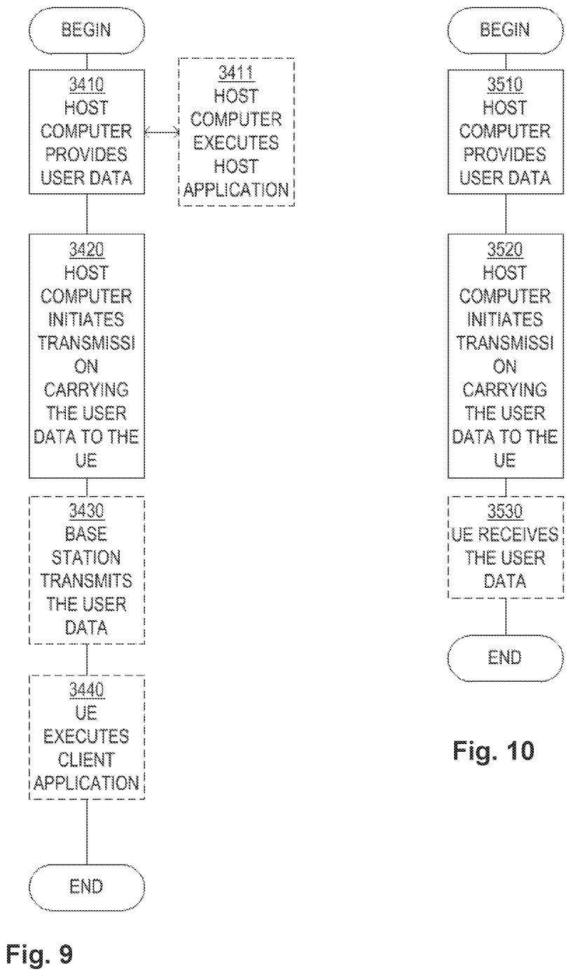

FIG. 35 illustrates methods implemented in a communication system comprising a host computer, a base station and a UE. FIG. 35 is a flowchart illustrating a method implemented in a communication system. The communication system comprises a host computer, a base station and a UE which may be those described with reference to FIG. 32 and FIG. 33. For simplicity of the present disclosure, only drawing references to FIG. 35 will be comprised in this section. In step 3510 of the method, the host computer provides user data. In an optional substep (not shown) the host computer provides the user data by executing a host application. In step 3520, the host computer initiates a transmission carrying the user data to the UE. The transmission may pass via the base station. In step 3530 (which may be optional), the UE receives the user data carried in the transmission.

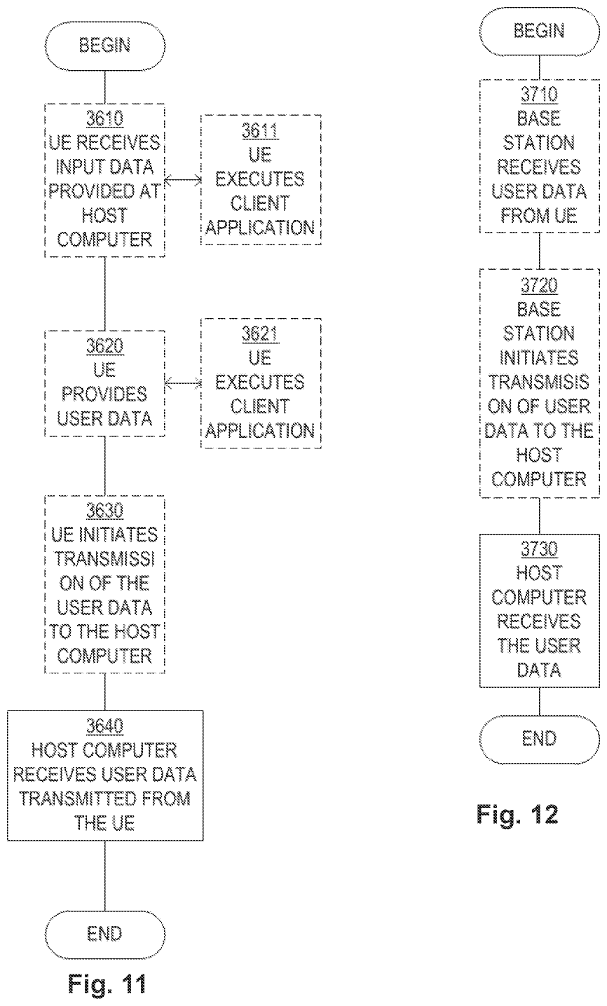

FIG. 36 illustrates methods implemented in a communication system comprising a host computer, a base station and a user equipment. FIG. 36 is a flowchart illustrating a method implemented in a communication system. The communication system comprises a host computer, a base station 101 and a UE 103 which may be those described with reference to FIG. 32 and FIG. 33. For simplicity of the present disclosure, only drawing references to FIG. 36 will be comprised in this section. In step 3610 (which may be optional), the UE 103 receives input data provided by the host computer. Additionally or alternatively, in step 3620, the UE 103 provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may consider user input received from the user. Regardless of the specific manner in which the user data was provided, the UE initiates, in substep 3630 (which may be optional), transmission of the user data to the host computer. In step 3640 of the method, the host computer receives the user data transmitted from the UE.

FIG. 37 illustrates methods implemented in a communication system comprising a host computer, a base station and a UE. FIG. 37 is a flowchart illustrating a method implemented in a communication system. The communication system comprises a host computer, a base station and a UE which may be those described with reference to FIG. 32 and FIG. 33. For simplicity of the present disclosure, only drawing references to FIG. 37 will be comprised in this section. In step 3710 (which may be optional), the base station receives user data from the UE. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station configured to communicate with a UE 103. The base station comprises a radio interface and processing circuitry configured to perform one or more of the actions described herein as performed by the network node 101.

A communication system 100 comprising a host computer comprising:
processing circuitry configured to provide user data; and
a communication interface configured to forward the user data to a cellular network for transmission to a UE 103,
the cellular network comprises a base station 101 having a radio interface and processing circuitry, the base station's processing circuitry configured to perform one or more of the actions described herein as performed by the network node 101.

The communication system may comprise the base station 101.

The communication system may comprise the UE 103. The UE 103 is configured to communicate with the base station 101.

The communication system, wherein:
the processing circuitry of the host computer is configured to execute a host application, thereby providing the user data; and
the UE 103 comprises processing circuitry configured to execute a client application associated with the host application.

A method implemented in a base station 101, comprising one or more of the actions described herein as performed by the network node 101.

A method implemented in a communication system 100 comprising a host computer, a base station and a UE 103, the method comprising:
at the host computer, providing user data; and
at the host computer, initiating a transmission carrying the user data to the UE 103 via a cellular network comprising the base station 101, wherein the base station 101 performs one or more of the actions described herein as performed by the network node 101.

The method may comprise:
at the base station 101, transmitting the user data.

The user data may be provided at the host computer by executing a host application, and the method may comprise:
at the UE 103, executing a client application associated with the host application.

A UE 103 configured to communicate with a base station 101. The UE 103 comprises a radio interface and processing circuitry configured to perform one or more of the actions described herein as performed by the UE 103.

A communication system 100 comprising a host computer comprising:
processing circuitry configured to provide user data; and
a communication interface configured to forward user data to a cellular network for transmission to a UE 103,
wherein the UE comprises a radio interface and processing circuitry, the UE's processing circuitry configured to perform one or more of the actions described herein as performed by the UE 103.

The communication system may comprise the UE 103.

The communication system 100, wherein the cellular network comprises a base station 101 configured to communicate with the UE 103.

The communication system 100, wherein:
the processing circuitry of the host computer is configured to execute a host application, thereby providing the user data; and
the UE's processing circuitry is configured to execute a client application associated with the host application.

A method implemented in a UE 103, comprising one or more of the actions described herein as performed by the UE 103.

A method implemented in a communication system 100 comprising a host computer, a base station 101 and a UE 103, the method comprising:
at the host computer, providing user data; and
at the host computer, initiating a transmission carrying the user data to the UE 103 via a cellular network comprising the base station, wherein the UE 103 performs one or more of the actions described herein as performed by the UE 103.

The method may comprise:
at the UE 103, receiving the user data from the base station 101.

A UE 103 configured to communicate with a base station 101, the UE 103 comprising a radio interface and processing circuitry configured to perform one or more of the actions described herein as performed by the UE 103.

A communication system 100 comprising a host computer comprising:
a communication interface configured to receive user data originating from a transmission from a UE 103 to a base station 101,
wherein the UE 103 comprises a radio interface and processing circuitry, the UE's processing circuitry configured to: perform one or more of the actions described herein as performed by the UE 103.

The communication system 100 may comprise the UE 103.

The communication system 100 may comprise the base station 101. The base station 101 comprises a radio interface configured to communicate with the UE 103 and a communication interface configured to forward to the host computer the user data carried by a transmission from the UE 103 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 103, comprising one or more of the actions described herein as performed by the UE 103.

The method may comprise:
providing user data; and
forwarding the user data to a host computer via the transmission to the base station 101.

A method implemented in a communication system 100 comprising a host computer, a base station 101 and a UE 103, the method comprising:
at the host computer, receiving user data transmitted to the base station 101 from the UE 103, wherein the UE 103 performs one or more of the actions described herein as performed by the UE 103.

The method may comprise:
at the UE 103, providing the user data to the base station 101.

The method may comprise:
at the UE 103, executing a client application, thereby providing the user data to be transmitted; and
at the host computer, executing a host application associated with the client application.

The method may comprise:
at the UE 103, executing a client application; and
at the UE 103, receiving input data to the client application, the input data being provided at the host computer by executing a host application associated with the client application,
wherein the user data to be transmitted is provided by the client application in response to the input data.

A base station 101 configured to communicate with a UE 103. The base station 101 comprises a radio interface and processing circuitry configured to perform one or more of the actions described herein as performed by the network node 101.

A communication system 100 comprising a host computer comprising a communication interface configured to receive user data originating from a transmission from a UE 103 to a base station. The base station 101 comprises a radio interface and processing circuitry. The base station's processing circuitry is configured to perform one or more of the actions described herein as performed by the network node 101.

The communication system 100 may comprise the base station 101.

The communication system 100 may comprise the UE 103. The UE 103 is configured to communicate with the base station 101.

The communication system 100 wherein:
the processing circuitry of the host computer is configured to execute a host application;
the UE 103 is configured to execute a client application associated with the host application, thereby providing the user data to be received by the host computer.

A method implemented in a base station 101 comprising one or more of the actions described herein as performed by any of the network node 101.

A method implemented in a communication system comprising a host computer, a base station 101 and a UE 103. The method comprises:
at the host computer, receiving, from the base station 101, user data originating from a transmission which the base station has received from the UE 103, wherein the UE 103 performs one or more of the actions described herein as performed by the UE 103.

The method may comprise:
at the base station 101, receiving the user data from the UE 103.

The method may comprise:
at the base station 101, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

It should be noted that the examples herein are not mutually exclusive.

The present disclosure is not limited to the above description. Various alternatives, modifications and equivalents may be used. Therefore, the above description should not be taken as limiting the scope.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

1.-46. (canceled)

47. A method performed by a User Equipment, UE, for handling signing of system information, SI, the method comprising:
obtaining, from a network node, a first indication which indicates that a first network is adapted to sign the SI, wherein the signed SI is signed by the first network using a signature;
obtaining, from a network node, a second indication which indicates which parts of the SI that is covered by the signature, wherein the SI is previously received, currently received or received in the future;
obtaining, from the network node, a third indication which indicates at least one second network that is adapted to sign the SI;
obtaining, from the network node, a fourth indication which indicates at least one of: which parts of the first network which is adapted to sign the SI and which parts of the first network which is not adapted to sign the SI;
receiving the SI from the network node;
determining if the received SI is signed or not;
authenticating the received SI using the signature if it is signed; and
applying the received SI if is not signed or if the authentication is successful.

48. The method according to claim 47, wherein a first part of the received signed SI is always covered by the signature, and wherein the first part indicates at least one second part of the received signed SI that is also covered by the signature.

49. The method according to claim 47, comprising:
applying the received signed SI without verifying the signature when the UE attaches to the first network for the first time.

50. The method according to claim 47, wherein the first indication is associated with a timer, and wherein the first network is adapted to sign the SI when the timer is running.

51. The method according to claim 47, further comprising:
providing information to the first network about presence or absence of signatures in the SI that the UE has received.

52. The method according to claim 51, comprising:
obtaining, from the network node, information about presence or absence of signatures in the SI that the UE has received from the first network, wherein the information is obtained after the UE has provided the same information to the first network, and wherein the information is security protected.

53. The method according to claim 52, comprising:
comparing the obtained and provided information about presence or absence of signatures in the SI; and
determining that the obtained information is correct when the comparison indicates that the obtained and provided information are at least substantially the same.

54. A method performed by a network node for handling signing of system information, SI, the method comprising:
providing, to the UE, a first indication which indicates that a first network is adapted to sign the SI, wherein the signed SI is signed by the first network using a signature;
providing, to the UE, a second indication which indicates which parts of the SI that is covered by the signature, wherein the SI is previously transmitted, currently transmitted or transmitted in the future;
providing, to the UE, a third indication which indicates at least one second network that is adapted to sign the SI;
providing, to the UE, a fourth indication which indicates at least one of: which parts of the first network which is adapted to sign the SI and which parts of the first network which is not adapted to sign the SI;
determining if SI should be signed or not;
signing the SI if it has been determined to do so; and
transmitting signed or unsigned SI to the UE.

55. The method according to claim 54, wherein a first part of the transmitted signed SI is always covered by the signature, and wherein the first part indicates at least one second part of the transmitted signed SI that is also covered by the signature.

56. The method according to claim 54, comprising:
receiving the first indication from a core network, CN, node.

57. The method according to claim 54, wherein the first indication is associated with a timer, and wherein the first network is adapted to sign the SI when the timer is running.

58. The method according to claim 54, further comprising:
obtaining information from the UE about presence or absence of signatures in the SI that the UE has received from the network node.

59. The method according to claim 54, comprising:
providing the information about presence or absence of signatures in the SI that the UE has received from the first network, wherein the information is provided after the network node has obtained the same information from the UE, and wherein the information is security protected.

60. A User Equipment, UE, for handling signing of system information, SI, the UE being adapted to:
obtain, from a network node, a first indication which indicates that a first network is adapted to sign the SI, wherein signed SI is signed by the first network using a signature;
obtain, from the network node, a second indication which indicates which parts of the system information that is covered by the signature, wherein the system information is previously received, currently received or received in the future;
obtain, from the network node, a third indication which indicates at least one second network that is adapted to sign the SI;
obtain, from the network node, a fourth indication which indicates at least one of: which parts of the first network which is adapted to sign the SI and which parts of the first network which is not adapted to sign the SI;
receive the SI from the first network;
determine if the received SI is signed or not;
authenticate the received SI using the signature if it is signed; and to
apply the received SI if it is not signed or if the authentication is successful.

61. The UE according to claim 60, wherein a first part of the received signed SI is always covered by the signature, and wherein the first part indicates at least one second part of the received signed SI that is also covered by the signature.

62. The UE according to claim 60, adapted to:
applying the received signed SI without verifying the signature when the UE attaches to the first network for the first time.

63. The UE according to claim 60, wherein the first indication is associated with a timer, and wherein the first network is adapted to sign the SI when the timer is running.

64. The UE according to claim 60, adapted to:
provide information to the first network about presence or absence of signatures in the SI that the UE has received.

65. A network node for handling signing of system information, SI, the network node being adapted to:
provide, to the UE, a first indication which indicates that a first network is adapted to sign the SI, wherein the signed SI is signed by the first network using a signature;
provide, to the UE, a second indication which indicates which parts of the system information that is covered by the signature, wherein the system information is previously received, currently received or received in the future;
provide, to the UE, a third indication which indicates at least one second network that is adapted to sign the SI;
provide, to the UE, a fourth indication which indicates at least one of: which parts of the first network which is adapted to sign the SI and which parts of the first network which is not adapted to sign the SI;
determine if the SI should be signed or not;
sign the SI if it has been determined to do so; and to transmit signed or unsigned SI to the UE.

66. The network node according to claim 65, wherein a first part of the transmitted signed SI is always covered by the signature, and wherein the first part indicates at least one second part of the received signed SI that is also covered by the signature.

67. The network node according to claim 65, adapted to receive the first indication from a core network, CN, node.

68. The network node according to claim 65, wherein the first indication is associated with a timer, and wherein the first network is adapted to sign the SI when the timer is running.
